(19) United States
(12) Patent Application Publication
(10) Pub. No.: US 2013/0297627 A1
(43) Pub. Date: Nov. 7, 2013

(54) BUSINESS INTELLIGENCE ENGINE

(71) Applicant: Sandeep J. Shah, San Diego, CA (US)

(72) Inventor: Sandeep J. Shah, San Diego, CA (US)

(21) Appl. No.: 13/465,973

(22) Filed: May 7, 2012

(51) Int. Cl. G06F 17/30

(52) U.S. Cl. 707/755; 707/E17.009

(57) ABSTRACT

Embodiments of the present invention provide a business intelligence engine, comprising: a processor; and at least one computer program residing on the processor; wherein the computer program is stored on a non-transitory computer readable medium having computer executable program code embodied thereon, the computer executable program code configured to: receive data from a entity; translate the data into a staging database; extract the data from the staging database; execute and manipulate the data from the staging database and transmit the data to a transaction database or a business intelligence database; and cause a reporting services to extract data from the transactional database or the business intelligence database.

### TECHNICAL FIELD

The present invention relates generally to business intelligence engines.

### DESCRIPTION OF THE RELATED ART

Without significant investment in IT infrastructure and human resources, industries such as financial institutions are not able to: (i) segment client data from their various sources and create meaningful demographic profiles that can then be easily acted upon, and (ii) subsequently proliferate documentation across myriad media platforms.

There are many existing email services providers (ESPs) that can segment data brought into their systems. These ESPs only segment generically such that they do not and cannot segment on the variables within a specific industry. Additionally, such ESPs cannot maintain complex relationships such as “house holding” across various accounts belonging to a family or trust. Furthermore, existing ESP's do not integrate to other media devices\platforms such as email service providers, landing page analytics providers, mobile phone, tablets etc., without significant custom code.

All known business intelligence applications stop at producing a report that requires interpretation. Business intelligence applications look at trends over time and do not integrate automatically and seamlessly with media platforms. A financial institution must build interfaces to the different services they want to utilize. The financial institution would then have to maintain many such services.

### BRIEF SUMMARY OF EMBODIMENTS OF THE INVENTION

Embodiments of the present invention provide systems and methods for providing a business intelligence engine.

One such embodiment is directed toward a business intelligence engine, comprising: a processor; and at least one computer program residing on the processor; wherein the computer program is stored on a non-transitory computer readable medium having computer executable program code embodied thereon, the computer executable program code configured to: receive data from an entity such as a financial institution or other firm within other industries; translate the data into a staging database; extract the data from the staging database; execute and manipulate the data from the staging database and transmit the data to a transaction database or a business intelligence database; and cause a reporting services to extract data from the transactional database or the business intelligence database.

According to some embodiments, data is transmitted by the entity to the business intelligence engine using the Secure File Transfer Protocol. In addition, receiving data from the entity may comprise the business intelligence engine retrieving the data. Communication between the entity and the business intelligence engine may be provided via a web server hosted by the business intelligence engine. In the business intelligence engine, the transaction database is used to store daily account information, while the business intelligence database is used to store demographic and aggregate account information. The demographic information can be used to send specific, tailored messages across a selected industry. In some cases, the business intelligence engine is used to segment the data into meaningful demographic profiles, and then automatically and seamlessly integrate these demographics with other cloud based and/or media based services. In some embodiments, the computer executable program code may be further configured to cause (i) the transaction database to insert data into the intelligence database by way of a data transformation, and/or (ii) the reporting services to format the data according to a selected cloud-based application.

Another embodiment of the invention is directed toward a non-transitory computer readable medium having computer executable program code embodied thereon, the computer executable program code configured to cause a business intelligence engine to: receive data from an entity such as a financial institution or other firm; translate the data into a staging database; extract the data from the staging database; execute and manipulate the data from the staging database and transmit the data to a transaction database or a business intelligence database; and cause a reporting services to extract data from the transactional database or the business intelligence database.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram depicting an exemplary business intelligence engine and method of use, in accordance with an embodiment of the invention.

FIG. 2 is a diagram illustrating an exemplary computing module that may be used to implement any of the embodiments disclosed herein.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

Embodiments of the present invention are directed toward systems and methods for providing a business intelligence engine.

Some embodiments provide the ability to: (i) seamlessly extract data from an entity such as a financial institution or other firm within other industries, (ii) load & transform data into the business intelligence engine, and (iii) subsequently segment the data into meaningful demographic profiles, which can then be automatically and seamlessly integrated with other cloud based and/or media based services.

Further embodiments of the invention provide the ability to easily load data in any format. Depending on the embodiment, this can be done automatically or manual, for example using Extensible Markup Language (XML) via Hypertext Transfer Protocol Secure (HTTPS), or remote procedure call (RPC). In addition, embodiments of the invention can: (i) load data from any source, (ii) translate the data into a transactional database engine, (iii) scrub the data for integrity, (iv) remove duplicates, (v) produce error reports of inconsistent data (e.g., William/Bill/Will or Suite 1/Suite #1/Apt 1/Floor 1) when data sources are consolidated for a particular record, and (vi) validates each field element for integrity. Additionally, some embodiments involve translating the data into a business intelligence engine and/or automatically communicating and transmitting the data to various cloud based services.

According to some embodiments of the invention, all data transfers (and static data) are wrapped in the tightest security and privacy policies. All data may further be archived/retained for a configurable amount of time. In most cases, all data transfer, translation, etc., can be accomplished within one week (depending on client availability). Conventionally, the integration of a business intelligence platform would take months or not years. Once integrated, the data transfer, load and translation are automatic and can be real-time.

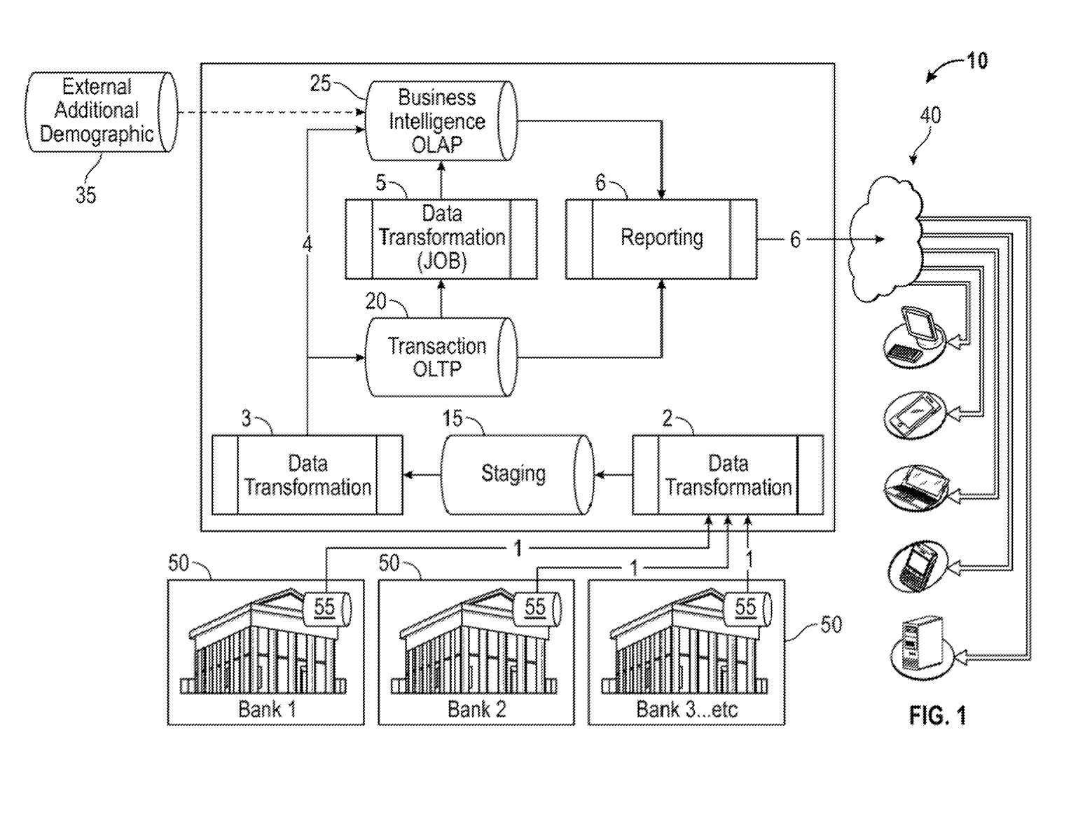

Referring to FIG. 1, an exemplary business intelligence engine 10 and method of use, will now be described. In particular, the business intelligence engine 10 includes a raw staging table database 15 that can easily consume any transactional information data, a transaction OLTP (online transaction processing) database 20, a business intelligence OLAP (online analytical processing) database 25. In some cases, the business intelligence engine 10 may receive input from an external additional demographic database 35. In addition, the business intelligence engine 10 has a one-to-many relationship with various cloud based vendors 40. In some embodiments, the business intelligence engine 10 creates demographic profiles and sends specific information to each cloud-based vendor 40. In operation, a financial institution 50 having a database 55 may transfer pertinent data to the business intelligence engine 10.

With continued reference to FIG. 1, a method of using the business intelligence engine 10 will now be described. Specifically, operation 1 entails a financial institution gathering pertinent data regarding their account holders and sending the data to the business intelligence engine 10. The financial institution 50 can transmit the data to the business intelligence engine 10 using the Secure File Transfer Protocol (SFTP), wherein either the business intelligence engine 10 or the financial institution 50 will host the SFTP site. In further embodiments, the financial institution 50 can call a secure API. Alternatively, the business intelligence engine 10 may be employed to retrieve the data. By way of example, communication may be provided via a web server hosted by the business intelligence engine 10. In this case, either the business intelligence engine 10 or the financial institution 50 may host an SFTP. Operation 2 involves a data transformation whereby the data received from the financial institution 50 is translated into the staging database 15 (which may be hosted on a web server). The data can be retrieved from any open data port (associated with a particular financial institution 50).

With further reference to FIG. 1, operation 3 involves a data transformation whereby the data is extracted from the staging database 15. Operation 4 entails executing and manipulating the data from the staging database 15 and transmitting the data to the transaction database 20 or the business intelligence database 25. The transaction database 20 is used to store daily account information, whereas the business intelligence database 25 is used to store demographic and aggregate account information. Once updated, the transaction database 20 will also insert data into the intelligence database 25 by way of a further data transformation (operation 5). Operation 6 involves a reporting services extracting data from the transactional database 20 and/or the business intelligence database 25, and formatting the data according to the cloud-based application 40. In operation 6, the data is sent to the cloud-based application 40.

According to further embodiments of the invention, the demographics stored in the business intelligence engine 25 (non financial data structures) can be used to send specific, tailored messages across any industry. As a result, the business intelligence engine can be used to segment the data into meaningful demographic profiles, and then automatically and seamlessly integrate these demographics with other cloud based and/or media based services.

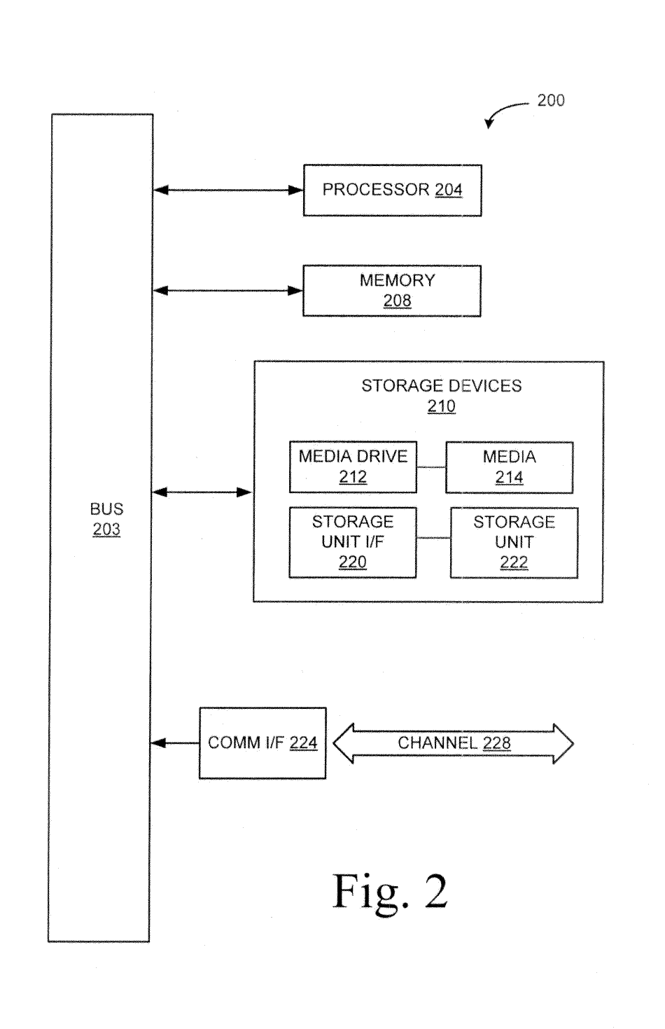

As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 2. Various embodiments are described in terms of this example-computing module 200. After reading this description, it will become apparent to a person skilled in the relevant art how to implement the invention using other computing modules or architectures.

Referring now to FIG. 2, computing module 200 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 200 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 200 might include, for example, one or more processors, controllers, control modules, or other processing devices, such as a processor 204. Processor 204 might be implemented using a general-purpose or special-purpose processing engine such as, for example, a microprocessor, controller, or other control logic. In the illustrated example, processor 204 is connected to a bus 203, although any communication medium can be used to facilitate interaction with other components of computing module 200 or to communicate externally.

Computing module 200 might also include one or more memory modules, simply referred to herein as main memory 208. For example, preferably random access memory (RAM) or other dynamic memory, might be used for storing information and instructions to be executed by processor 204. Main memory 208 might also be used for storing temporary variables or other intermediate information during execution of instructions to be executed by processor 204. Computing module 200 might likewise include a read only memory (“ROM”) or other static storage device coupled to bus 203 for storing static information and instructions for processor 204.

The computing module 200 might also include one or more various forms of information storage mechanism 210, which might include, for example, a media drive 212 and a storage unit interface 220. The media drive 212 might include a drive or other mechanism to support fixed or removable storage media 214. For example, a hard disk drive, a floppy disk drive, a magnetic tape drive, an optical disk drive, a CD, DVD or Blu-ray drive (R or RW), or other removable or fixed media drive might be provided. Accordingly, storage media 214 might include, for example, a hard disk, a floppy disk, magnetic tape, cartridge, optical disk, a CD, DVD or Blu-ray, or other fixed or removable medium that is read by, written to or accessed by media drive 212. As these examples illustrate, the storage media 214 can include a computer usable storage medium having stored therein computer software or data.

In alternative embodiments, information storage mechanism 210 might include other similar instrumentalities for allowing computer programs or other instructions or data to be loaded into computing module 200. Such instrumentalities might include, for example, a fixed or removable storage unit 222 and an interface 220. Examples of such storage units 222 and interfaces 220 can include a program cartridge and cartridge interface, a removable memory (for example, a flash memory or other removable memory module) and memory slot, a PCMCIA slot and card, and other fixed or removable storage units 222 and interfaces 220 that allow software and data to be transferred from the storage unit 222 to computing module 200.

Computing module 200 might also include a communications interface 224. Communications interface 224 might be used to allow software and data to be transferred between computing module 200 and external devices. Examples of communications interface 224 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 224 might typically be carried on signals, which can be electronic, electromagnetic (which includes optical) or other signals capable of being exchanged by a given communications interface 224. These signals might be provided to communications interface 224 via a channel 228. This channel 228 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 208, storage unit 220, media 214, and channel 228. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 200 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A business intelligence engine, comprising:
a non-transitory computer readable medium configured to store executable programmed modules;
a processor communicatively coupled with the non-transitory computer readable medium configured to execute programmed modules stored therein; and
at least one computer program stored in the non-transitory computer readable medium and configured to be executed by the processor;
wherein the at least one computer program is configured to:
fetch or receive data from an entity;
translate the data into a staging database;
extract the data from the staging database;
execute and manipulate the data from the staging database and transmit the data to a transaction database, wherein the transaction database is used to store daily account information;
cause the transaction database to insert said daily account information data into a business intelligence database by way of a data transformation that aggregates account information, wherein the business intelligence database is used to store demographic and aggregate account information; and
cause a reporting services to extract data from the transactional database or the business intelligence database.

2. The business intelligence engine of claim 1, wherein the data is received by the business intelligence engine using the Secure File Transfer Protocol.

3. The business intelligence engine of claim 1, wherein receiving data from the entity comprises the business intelligence engine retrieving the data.

4. The business intelligence engine of claim 3, further comprising a web server configured to provide communication between the entity and the business intelligence engine.

5. (canceled)

6. (canceled)

7. The business intelligence engine of claim 1, wherein the demographic information is used to send specific, tailored messages across a selected industry.

8. The business intelligence engine of claim 1, wherein the business intelligence engine is used to segment the data into meaningful demographic profiles, and automatically and seamlessly integrate these demographics with other cloud based and/or media based services.

9. (canceled)

10. The business intelligence engine of claim 1, wherein the computer executable program code is further configured to cause the reporting services to format the extracted data according to a selected cloud-based application.

11. A non-transitory computer readable medium having computer executable program code embodied thereon, the computer executable program code configured to cause a business intelligence engine to:
receive or fetch data from an entity;
translate the data into a staging database;
extract the data from the staging database;
execute and manipulate the data from the staging database and transmit the data to a transaction database, wherein the transaction database is used to store daily account information;
cause the transaction database to insert said daily account information data into a business intelligence database by way of a data transformation that aggregates account information, wherein the business intelligence database is used to store demographic and aggregate account information; and
cause a reporting services to extract data from the transactional database or the business intelligence database.

12. The computer readable medium of claim 11, wherein the data is received by the business intelligence engine using the Secure File Transfer Protocol.

13. The computer readable medium of claim 11, wherein receiving data from the entity comprises the business intelligence engine retrieving the data.

14. The computer readable medium of claim 13, further comprising a web server configured to provide communication between the entity and the business intelligence engine.

15. (canceled)

16. (canceled)

17. The computer readable medium of claim 11, wherein the computer executable program code is further configured to use the demographic information to send specific, tailored messages across a selected industry.

18. The computer readable medium of claim 11, wherein the computer executable program code is further configured to segment the data into meaningful demographic profiles, and then automatically and seamlessly integrate these demographics with other cloud based and/or media based services.

19. (canceled)

20. The computer readable medium of claim 11, wherein the computer executable program code is further configured to cause the reporting services to format the extracted data according to a selected cloud-based application.
